(19) United States
(12) Patent Application Publication
(10) Pub. No.: US 2016/0063538 A1
(43) Pub. Date: Mar. 3, 2016

(54) MARKETING PLATFORM THAT DETERMINES ADVERTISEMENTS AND MARKETING CHANNELS FOR THE ADVERTISEMENTS

(71) Applicant: Verizon Patent and Licensing Inc., Arlington, VA (US)

(72) Inventors: Ashok N. SRIVASTAVA, Mountain View, CA (US); Gaurav GOEL, Los Gatos, CA (US)

(21) Appl. No.: 14/472,913

(22) Filed: Aug. 29, 2014

(51) Int. Cl. G06Q 30/02

(52) U.S. Cl. CPC G06Q 30/0244; G06Q 30/0249; G06Q 30/0269; G06Q 30/0242

(57) ABSTRACT

A device receives user information associated with users of user devices, and receives marketing information associated with products and services. The marketing information includes information associated with advertisements for the products and the services. The device generates user profiles, associated with the users, based on the user information and the marketing information, and groups the user profiles based on the user information to create user segments. The device generates scores for the advertisements based on the marketing information, and correlates the advertisements with users of the user segments based on the scores for the advertisements. The device determines marketing channels for the advertisements based on the marketing information and the correlated user segments, and causes the advertisements to be provided to user devices associated with the users of the correlated user segments, via the determined marketing channels.

### BACKGROUND

Users today utilize a variety of user devices, such as cell phones, smart phones, tablet computers, etc., to access online services (e.g., email applications, Internet services, television services, etc.), purchase products and/or services, and/or perform other tasks.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIGS. 4A and 4B depict a flow chart of an example process for determining advertisements and marketing channels for the advertisements; and

FIGS. 5A-5H are diagrams of an example relating to the example process shown in FIGS. 4A and 4B.

### DETAILED DESCRIPTION OF PREFERRED EMBODIMENTS

The following detailed description refers to the accompanying drawings. The same reference numbers in different drawings may identify the same or similar elements.

Information associated with user devices (e.g., locations of the user devices when tasks are performed, times associated with when the user devices perform the tasks, network resources utilized by the user devices, etc.) and information associated with content accessed by the user devices (e.g., clickstream information associated with the user devices) may be collected by a provider of a network. Information associated with the users (e.g., preferences and other information) may be shared with vendors (e.g., businesses, organizations, etc.) that provide such products and/or services so that the users can access and interact with the vendors in an efficient manner.

Vendors are constantly trying to find out as much about users as possible so that the vendors can market appropriate products and/or services to the users via advertisements (ads). However, most vendors know very little about the users of their products and/or services. The vendors may utilize multiple marketing channels (e.g., online advertisements, email advertisements, etc.) to provide the advertisements to the users. Thus, the vendors are also constantly trying to figure out how to allocate a marketing budget so that appropriate advertisements are provided to appropriate users at appropriate times and via appropriate marketing channels.

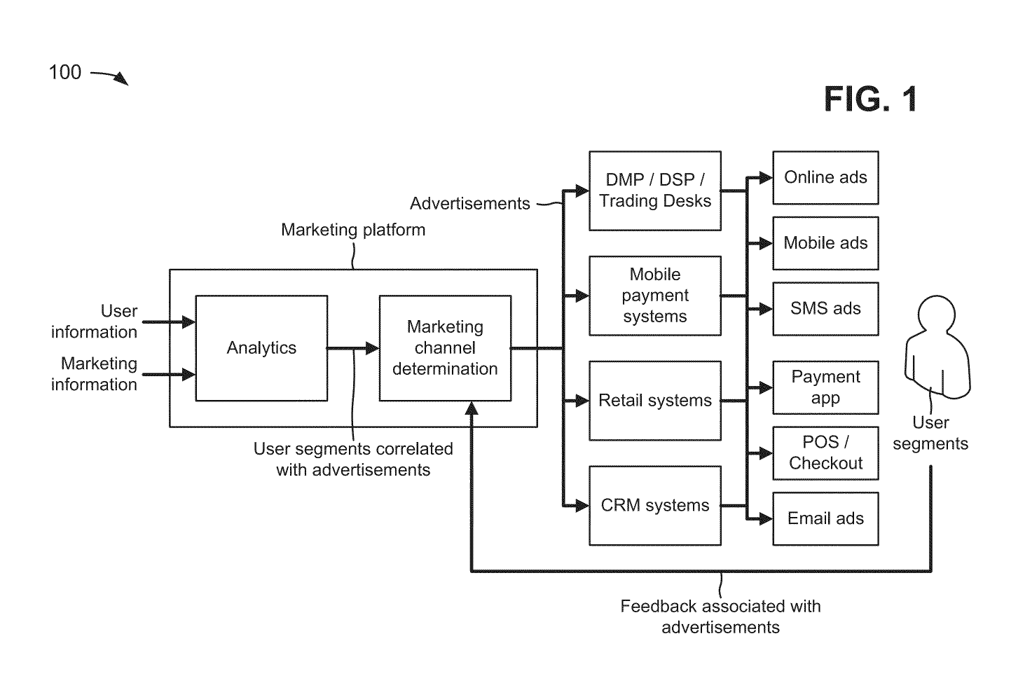

FIG. 1 is a diagram of an overview of an example implementation 100 described herein. In example implementation 100, assume that a marketing platform receives user information and marketing information. The user information may be generated by multiple user devices, associated with users, and may include information associated with the user devices and the users (e.g., account information, demographic information, etc.); network information (e.g., information associated with network resources utilized by the user devices); network usage information associated with the user devices; content accessed by the user devices; transactions associated with the user devices; clickstream information associated with the user devices; location information associated with the user devices; time information associated with the user devices; etc. The clickstream information may include information associated with portions of user interfaces that users select (e.g., or click on) while web browsing (e.g., accessing content) or using another software application. The location information may include information associated with locations (e.g., global positioning system (GPS) coordinates, cellular triangulation locations, etc.) of the user devices when content is accessed by the user devices. The time information may include information associated with times when the user devices access the content (e.g., dates and times when the content is accessed, an amount of time the user devices are performing online activities, such as browsing, etc.). The user information may be stored in the user devices and/or in a network resource (e.g., a server), and provided to the marketing platform.

The marketing information may include information associated with products and/or services offered by vendors and to be marketed to the users; advertisements for the products and/or the services offered by the vendors; offers for the products and/or the services; marketing campaign information (e.g., a campaign for products and/or services, a marketing budget for the campaign, timing associated with the campaign, etc.); user information received by the vendors via interactions between the vendors and the users; etc.

The marketing platform may include an analytics component and a marketing channel determination component. The analytics component may create user profiles for the users based on the user information and the marketing information. For example, the analytics component may create a user profile, for a particular user, that includes a user identifier (ID) (e.g., a user name) and multiple attributes associated with the particular user (e.g., demographic information, location information, time information, user device information, etc.). The analytics component may group the user profiles, based on the user information, to create one or more groups of user profiles (e.g., referred to herein as “user segments”). For example, the analytics component may group some of the user profiles into a user segment that prefers a particular type of automobile and shops at a particular store.

The analytics component may identify advertisements in the marketing information, and may calculate scores for the advertisements based on the marketing information. For example, the analytics component may calculate greater scores for advertisements that generate sales for the vendors than advertisements that do not generate sales for the vendors. The analytics component may select particular advertisements based on the calculated scores, and may correlate the particular advertisements with the user segments. For example, the analytics component may correlate a user segment that drinks coffee with particular advertisements for coffee that have the greatest scores (e.g., in relation to scores of other advertisements for coffee).

As further shown in FIG. 1, the analytics component may provide, to the marketing channel determination component, information associated with the correlation between the user segments and the advertisements. The marketing channel determination component may determine marketing channels for the advertisements based on the marketing information (e.g., the marketing campaign information). For example, the marketing channels may include a data management platform (DMP) (e.g., a system that retrieves, sorts, stores, etc. information, and generates information for marketers, publishers, etc.), a demand-side platform (DSP) (e.g., a system that allows buyers of advertisements to manage multiple ad exchange and data exchange accounts), and/or trading desks (e.g., a mechanism where advertising space is listed for a price and where advertisers may purchase the advertising space); mobile payment systems; retail systems; customer relationship management (CRM) systems; etc., as shown in FIG. 1. The marketing channel determination component may cause the advertisements to be provided to corresponding user segments via the determined marketing channels. As further shown in FIG. 1, the marketing channels may provide the advertisements to the corresponding user segments in a variety of formats, such as via online advertisements (e.g., Internet advertisements), via mobile advertisements (e.g., advertisements via mobile devices), via short message service (SMS) advertisements, via a payment application (e.g., a credit card application, a debit card application, etc.), via a point of sale (POS) or checkout device (e.g., device at which a user makes a payment in exchange for products and/or services), via email advertisements, etc.

The user segments may receive the advertisements (e.g., via the user devices), and the users in the user segments may generate feedback (e.g., receipt of the advertisements, purchase products/services associated with the advertisements, do nothing, request that the advertisements not be provided in the future, etc.) associated with the advertisements. The user devices may provide the feedback to the marketing platform. The marketing platform may utilize the feedback to refine, improve, and/or modify the analytics component and/or the marketing channel determination component.

Systems and/or methods described herein may determine advertisements for user segments and appropriate marketing channels for the advertisements. The systems and/or methods may ensure that personalized advertisements are delivered to appropriate users, via appropriate marketing channels and at appropriate times and locations. The systems and/or methods may enable vendors to allocate marketing budgets so that the advertisements are provided to users in a most productive manner.

As used herein, the term user is intended to be broadly interpreted to include a user device, or a user of a user device. The term vendor, as used herein, is intended to be broadly interpreted to include a business, an organization, a government agency, a vendor server, a user of a vendor server, etc.

A product, as the term is used herein, is to be broadly interpreted to include anything that may be marketed or sold as a commodity or a good. For example, a product may include bread, coffee, bottled water, milk, soft drinks, pet food, beer, fuel, meat, fruit, automobiles, clothing, content, etc. The term content, as used herein, is to be broadly interpreted to include video, audio, images, software downloads, and/or combinations of video, audio, images, and software downloads.

A service, as the term is used herein, is to be broadly interpreted to include any act or variety of work done for others (e.g., for compensation). For example, a service may include a repair service (e.g., for a product), a warranty (e.g., for a product), a telecommunication service (e.g., a telephone service, an Internet service, a network service, a radio service, a television service, a video service, etc.), an automobile service (e.g., for selling automobiles), a food service (e.g., a restaurant), a banking service, a lodging service (e.g., a hotel), etc.

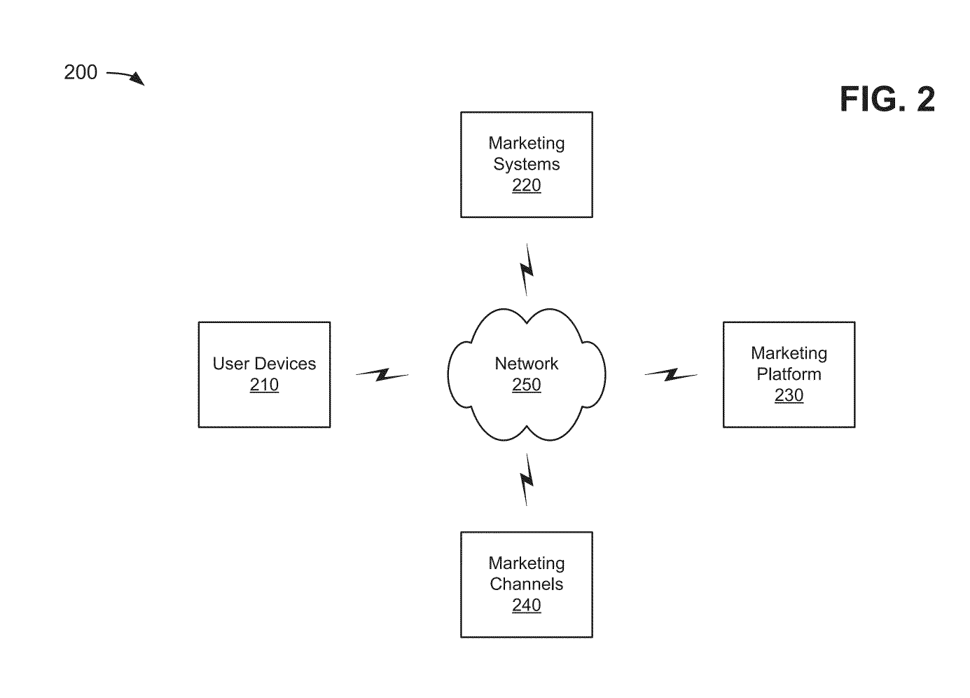

FIG. 2 is a diagram of an example environment 200 in which systems and/or methods described herein may be implemented. As illustrated, environment 200 may include user devices 210, marketing systems 220, a marketing platform 230, marketing channels 240, and a network 250. Devices/networks of environment 200 may interconnect via wired connections, wireless connections, or a combination of wired and wireless connections.

User device 210 may include a device that is capable of communicating over network 250 with marketing systems 220, marketing platform 230, and/or marketing channels 240. In some implementations, user device 210 may include a radiotelephone; a personal communications services (PCS) terminal that may combine, for example, a cellular radiotelephone with data processing and data communications capabilities; a smart phone; a personal digital assistant (PDA) that can include a radiotelephone, a pager, Internet/intranet access, etc.; a laptop computer; a configured television; a tablet computer; a global positioning system (GPS) device; a gaming device; or another type of computation and communication device.

Marketing system 220 may include one or more personal computers, one or more workstation computers, one or more server devices, one or more virtual machines (VMs) provided in a cloud computing network, or one or more other types of computation and communication devices. In some implementations, marketing system 220 may be associated with one or more vendors or other entities that provide marketing services for the vendors. In some implementations, marketing system 220 may enable vendors to generate marketing information, and to provide the marketing information to user devices 210 and/or marketing platform 230. The marketing information may include information associated with products and/or services offered by the vendors and to be marketed to the users; advertisements for the products and/or the services offered by the vendors; offers for the products and/or the services; marketing campaign information (e.g., a campaign for a particular product and/or service, a marketing budget for the campaign, timing associated with the campaign, etc.); interactions (e.g., transactions, creation of user accounts with the vendors, creation of user profiles with the vendors, etc.) between the vendors and the users (e.g., between marketing systems 220 and user devices 210); etc.

Marketing platform 230 may include one or more personal computers, one or more workstation computers, one or more server devices, one or more VMs provided in a cloud computing network, or one or more other types of computation and communication devices. In some implementations, marketing platform 230 may be associated with a service provider that manages and/or operates network 250, such as, for example, a telecommunication service provider, a television service provider, an Internet service provider, a wireless service provider, etc.

In some implementations, marketing platform 230 may receive user information associated with user devices 210, and may receive marketing information associated with products and/or services offered by vendors and/or marketed by marketing systems 220. Marketing platform 230 may create user profiles based on the user information and/or the marketing information, and may group the user profiles based on the user information to create user segments. Marketing platform 230 may identify advertisements in the marketing information, and may calculate scores for the advertisements based on the marketing information. Marketing platform 230 may rank the advertisements based on the calculated scores, and may correlate the advertisements with the user segments based on the rank. Marketing platform 230 may determine marketing channels for the correlated advertisements and user segments, based on marketing campaign information, and may cause the advertisements to be provided to user devices 210 associated with corresponding user segments and via the marketing channels. Marketing platform 230 may receive feedback associated with the advertisements from user devices 210 associated with the user segments, and may utilize the feedback to refine the determination of the marketing channels for the advertisements.

Marketing channel 240 may include one or more personal computers, one or more workstation computers, one or more server devices, one or more VMs provided in a cloud computing network, or one or more other types of computation and communication devices. In some implementations, marketing channel 240 may be associated with one or more vendors or other entities that provide marketing services to the vendors. In some implementations, marketing channel 240 may include may include a DMP/DSP/trading desk, a mobile payment system, a retail system, a CRM system, etc. In some implementations, marketing channel 240 may provide advertisements to user devices 210 in a variety of formats, such as via online advertisements, via mobile advertisements, via SMS advertisements, via a payment application, via a POS or checkout device, via email advertisements, etc.

Network 250 may include a network, such as a local area network (LAN), a wide area network (WAN), a metropolitan area network (MAN), a telephone network, such as the Public Switched Telephone Network (PSTN) or a cellular network, an intranet, the Internet, a fiber optic network, a satellite network, a cloud computing network, or a combination of networks.

In some implementations, the cellular network may include a fourth generation (4G) cellular network that includes an evolved packet system (EPS). The EPS may include a radio access network (e.g., referred to as a long term evolution (LTE) network), a wireless core network (e.g., referred to as an evolved packet core (EPC) network), an Internet protocol (IP) multimedia subsystem (IMS) network, and a packet data network (PDN). The LTE network may be referred to as an evolved universal terrestrial radio access network (E-UTRAN), and may include one or more base stations. The EPC network may include an all-Internet protocol (IP) packet-switched core network that supports high-speed wireless and wireline broadband access technologies. The EPC network may allow user devices 210 to access various services by connecting to the LTE network, an evolved high rate packet data (eHRPD) radio access network (RAN), and/or a wireless local area network (WLAN) RAN. The IMS network may include an architectural framework or network (e.g., a telecommunications network) for delivering IP multimedia services. The PDN may include a communications network that is based on packet switching. In some implementations, the cellular network may provide location information (e.g., latitude and longitude coordinates) associated with user devices 210. For example, the cellular network may determine a location of user device 210 based on triangulation of signals, generated by user device 210 and received by multiple base stations, with prior knowledge of the base stations.

In some implementations, the satellite network may include a space-based satellite navigation system (e.g., a global positioning system (GPS)) that provides location and/or time information in all weather conditions, anywhere on or near the Earth where there is an unobstructed line of sight to four or more satellites (e.g., GPS satellites). In some implementations, the satellite network may provide location information (e.g., GPS coordinates) associated with user devices 210, enable communication with user devices 210, etc.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

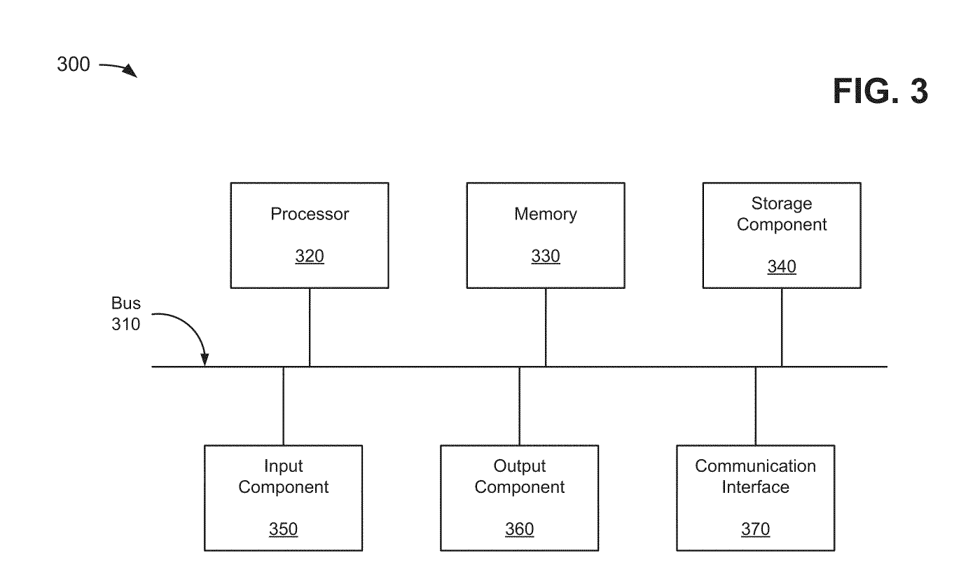

FIG. 3 is a diagram of example components of a device 300 that may correspond to one or more of the devices of environment 200. In some implementations, each of the devices of environment 200 may include one or more devices 300 or one or more components of device 300. As shown in FIG. 3, device 300 may include a bus 310, a processor 320, a memory 330, a storage component 340, an input component 350, an output component 360, and a communication interface 370.

Bus 310 may include a component that permits communication among the components of device 300. Processor 320 may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. Memory 330 may include a random access memory (RAM), a read only memory (ROM), and/or another type of dynamic or static storage device (e.g., a flash memory, a magnetic memory, an optical memory, etc.) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 350 may include a component that permits device 300 to receive information, such as via user input (e.g., a touch screen display, a keyboard, a keypad, a mouse, a button, a switch, a microphone, etc.). Additionally, or alternatively, input component 350 may include a sensor for sensing information (e.g., a global positioning system (GPS) component, an accelerometer, a gyroscope, an actuator, etc.). Output component 360 may include a component that provides output information from device 300 (e.g., a display, a speaker, one or more light-emitting diodes (LEDs), etc.).

Communication interface 370 may include a transceiver-like component (e.g., a transceiver, a separate receiver and transmitter, etc.) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 is provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

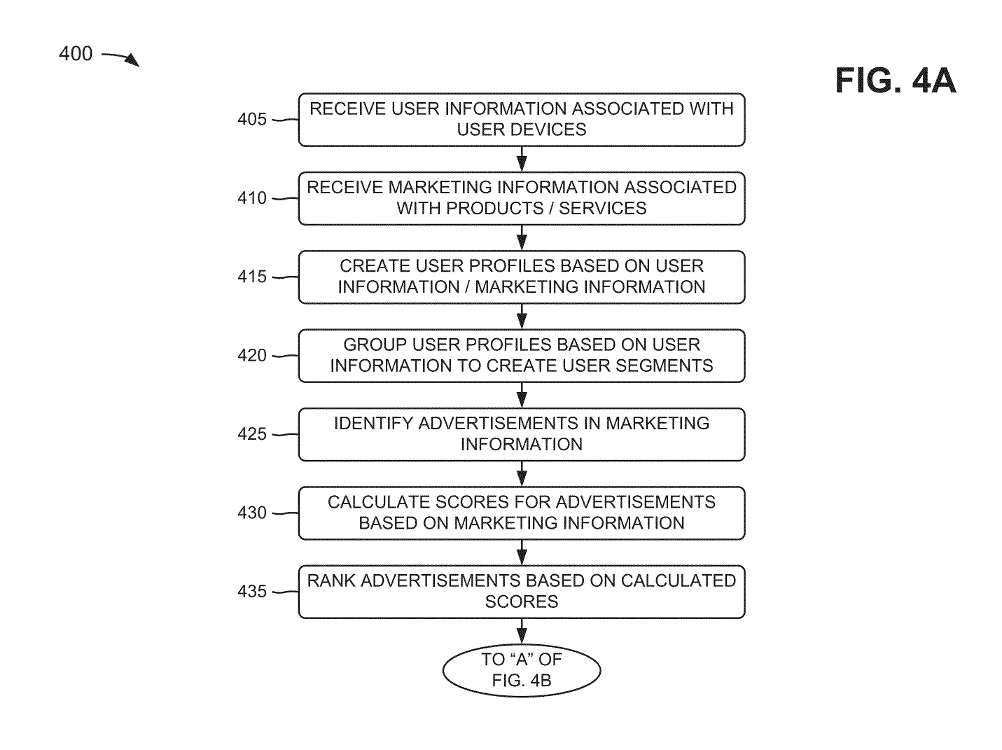

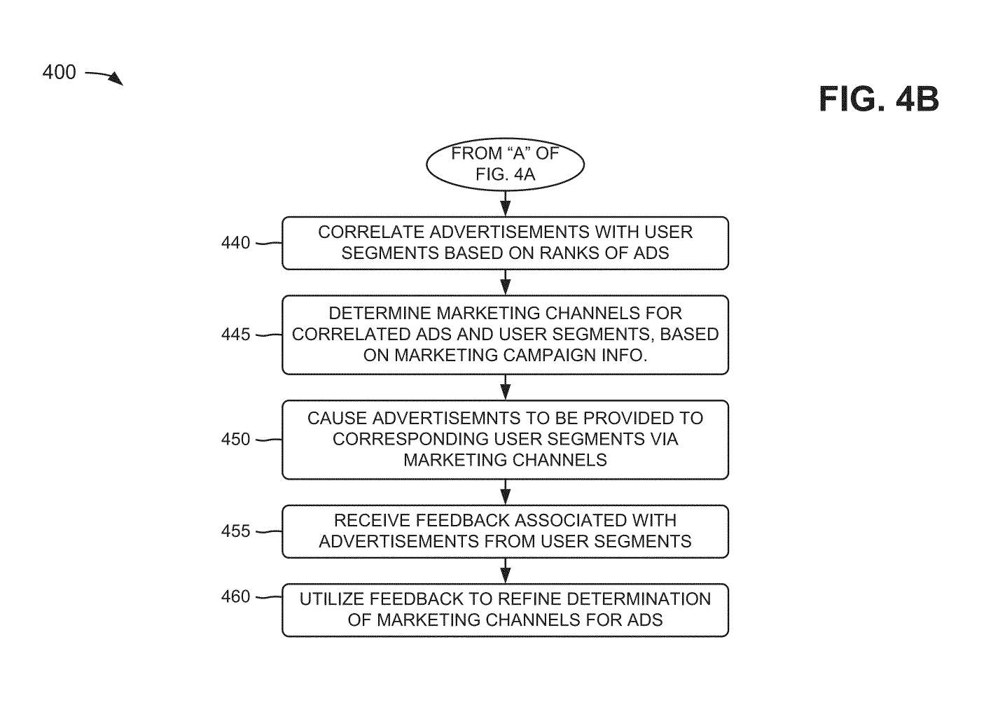

FIGS. 4A and 4B depict a flow chart of an example process 400 for determining advertisements and marketing channels for the advertisements. In some implementations, one or more process blocks of FIGS. 4A and 4B may be performed by marketing platform 230. In some implementations, one or more process blocks of FIGS. 4A and 4B may be performed by another device or a group of devices separate from or including marketing platform 230, such as user device 210, marketing system 220, and/or marketing channel 240.

As shown in FIG. 4A, process 400 may include receiving user information associated with user devices (block 405). For example, marketing platform 230 may receive, from user devices 210, user information associated with user devices 210. In some implementations, the user information may include information associated with user devices 210 (e.g., types of user devices 210, model numbers of user devices 210, etc.); information associated with the users of user devices 210 (e.g., account information, demographic information, etc.); network information (e.g., information associated with network resources of network 250 utilized by user devices 210); usage information associated with network 250 by user devices 210; content accessed by user devices 210; transactions associated with user devices 210; clickstream information associated with user devices 210; location information associated with user devices 210; time information associated with user devices 210; etc. In some implementations, the user information may be stored in user devices 210 and/or in a network resource (e.g., a server) of network 250, and provided to marketing platform 230.

As further shown in FIG. 4A, process 400 may include receiving marketing information associated with products and/or services (block 410). For example, marketing platform 230 may receive marketing information from marketing systems 220. The marketing information may include information associated with products and/or services, advertisements for the products and/or the services, etc.

As further shown in FIG. 4A, process 400 may include creating user profiles based on the user information and/or the marketing information (block 415). For example, marketing platform 230 may create user profiles, for the users, based on the user information and/or the marketing information. In some implementations, a user profile, for a particular user, may include a user identifier (ID) (e.g., a user name) and multiple attributes associated with the particular user (e.g., demographic information, location information, time information, user device information, interests, behavior, advertisements received, etc.). For example, assume that a particular user (e.g., Susan) utilizes a mobile user device 210 (e.g., a smart phone), and that location information associated with the smart phone indicates that Susan is at a particular location (e.g., at a beach) every weekend. Further, assume that Susan utilizes the smart phone to receive advertisements associated with restaurants at the beach. In such an example, marketing platform 230 may create a user profile for Susan that includes information indicating interests of Susan (e.g., Susan is interested in the beach), behavior of Susan (e.g., Susan travels to the beach), advertisements received by Susan (e.g., Susan receives beach restaurant advertisements via a mobile user device 210), etc.

In another example, assume that a particular user (e.g., Fred) utilizes a particular user device 210 (e.g., a gaming device) to play online games, and that Fred utilizes the gaming device to shop for online games. Further, assume that Fred utilizes the gaming device to receive advertisements associated with new online games when Fred shops for online games. In such an example, marketing platform 230 may create a user profile for Fred that includes information indicating interests of Fred (e.g., Fred is interested in online games), behavior of Fred (e.g., Fred shops online for games), advertisements received by Fred (e.g., Fred receives new online games advertisements via the gaming device), etc.

In still another example, assume that a particular user (e.g., Jane) plays golf, and utilizes a mobile user device 210 (e.g., a smart phone) when playing golf and to purchase golf equipment (e.g., golf clubs, golf balls, etc.). Further, assume that Jane utilizes the smart phone to receive advertisements associated with golf lessons when Jane purchases the golf equipment. In such an example, marketing platform 230 may create a user profile for Jane that includes information indicating interests of Jane (e.g., Jane is interested in golf), behavior of Jane (e.g., Jane purchases golf equipment via a mobile user device 210), advertisements received by Jane (e.g., Jane receives golf lesson advertisements via the mobile user device 210), etc.

As further shown in FIG. 4A, process 400 may include grouping the user profiles based on the user information to create user segments (block 420). For example, marketing platform 230 may group the user profiles, based on the user information, to create one or more groups of user profiles (e.g., user segments). In some implementations, marketing platform 230 may utilize agglomerative clustering to group the user profiles into the user segments based on the user information. The agglomerative clustering may include a method of cluster analysis that seeks to build a hierarchy of clusters. The agglomerative clustering may include a bottom up approach where each observation (e.g., from the user information) starts in a cluster (e.g., a user segment), and pairs of clusters are merged as the technique moves up the hierarchy. The agglomerative clustering may include one or more of the following metrics: Euclidean distance, squared Euclidean distance, Manhattan distance, maximum distance, Mahalanobis distance, cosine similarity, etc.

Alternatively, or additionally, marketing platform 230 may utilize matrix factorization to group the user profiles into the user segments based on the user information. The matrix factorization may include a factorization of a matrix into a product of matrices, and may include many different matrix decompositions. For example, the matrix factorization may include decompositions related to solving systems of linear equations, such as lower upper (LU) decomposition, LU reduction, block LU decomposition, rank factorization, Cholesky decomposition, QR decomposition (e.g., for an orthogonal matrix Q and an upper triangular matrix R), rank-revealing QR (RRQR) factorization, singular value decomposition, etc. In another example, the matrix factorization may include decompositions based on Eigen values, such as Eigen decomposition, Jordan decomposition, Schur decomposition, QZ decomposition (e.g., for unitary matrices Q and Z), Takagi's factorization, etc.

Alternatively, or additionally, marketing platform 230 may utilize K-means clustering to group the user profiles into the user segments based on the user information. The K-means clustering may include a method of vector quantization that may be used for cluster analysis in data mining. The K-means clustering may partition n observations (e.g., from the user information) into k clusters (e.g., user segments), in which each observation belongs to a cluster with a nearest mean serving as a prototype of the cluster. The K-means clustering may utilize efficient heuristic algorithms that converge quickly to a local optimum. The heuristic algorithms may include an expectation-maximization algorithm for mixtures of Gaussian distributions via an iterative refinement approach. The K-means clustering may utilize cluster centers to model data, and may determine clusters of comparable spatial extent.

In some implementations, marketing platform 230 may group the user profiles into the user segments in a manner that utilizes information associated with users of user devices 210, information associated with usage of network 250 by user devices 210, location information associated with user devices 210, and/or other attributes defined in the user profiles. In some implementations, marketing platform 230 may align the user segments with marketing objectives of the vendors, such as, for example, user engagement, user conversion, user loyalty, etc. For example, assume that three users (e.g., Bob, Joe, and Sally) of user devices 210 are interested in football, and that Joe and Sally watch football on their user devices 210. In such an example, marketing platform 230 may group Bob, Joe, and Sally into a user segment that is interested in football. The user segment may be targeted to receive advertisements associated with football (e.g., via a variety of marketing channels). Marketing platform 230 may also group Joe and Sally into another user segment that is interested in football and watches football on user devices 210. The other user segment may be targeted to receive advertisements associated with football (e.g., via user devices 210).

As further shown in FIG. 4A, process 400 may include identifying advertisements in the marketing information (block 425). For example, marketing platform 230 may identify advertisements in the marketing information. In some implementations, marketing platform 230 may identify, in the marketing information, advertisements for products and/or services associated with vendors. For example, assume that the marketing information includes information associated with a vendor (e.g., a sporting goods store), products offered by the vendor (e.g., sporting goods), and an online advertisement created by or for the sporting goods store. In such an example, marketing platform 230 may identify the online advertisement in the marketing information. In some implementations, marketing platform 230 may identify, in the marketing information, offers for products and/or services associated with vendors. For example, assume that the marketing information includes information associated with a vendor (e.g., a landscaper), products offered by the vendor (e.g., landscaping services), and an offer for 10% off the landscaping services. In such an example, marketing platform 230 may identify the offer in the marketing information.

As further shown in FIG. 4A, process 400 may include calculating scores for the advertisements based on the marketing information (block 430). For example, marketing platform 230 may calculate scores for the identified advertisements based on the marketing information. In some implementations, marketing platform 230 may assign weights (e.g., values, percentages, etc.) to different factors (e.g., of the marketing information) to be used to determine scores for the advertisements, such as whether the advertisements are received by users, whether users buy products/services based on the advertisements, a number of users that receive the advertisements, types of advertisements (e.g., online, print, email, etc.), etc. In some implementations, marketing platform 230 may calculate a score for each of the advertisements based on the factors and the assigned weights. For example, assume that marketing platform 230 assigns a weight of 0.3 to whether the advertisements are received by users, a weight of 0.9 to whether users buy products/services based on the advertisements, a weight of 0.4 to the number of users that receive the advertisements, and a weight of 0.1 to the types of advertisements. Further, marketing platform 230 may identify three advertisements (e.g., A, B, and C) in the marketing information, and may calculate a score of 0.8 for advertisement A, a score of 0.6 for advertisement B, and a score of 0.7 for advertisement C.

In some implementations, marketing platform 230 may calculate scores for identified advertisements based on a particular user segment. For example, assume that marketing platform 230 identifies a particular user segment that is interested in jeans, and identifies three advertisements (e.g., A, B, and C) for jeans in the marketing information. Further, marketing platform 230 may calculate a score of 0.4 for advertisement A, a score of 0.8 for advertisement B, and a score of 0.7 for advertisement C based on the factors and the assigned weights associated with the marketing information. In such an example, marketing platform 230 may target advertisement B for the particular user segment since advertisement B has the greatest score.

As further shown in FIG. 4A, process 400 may include ranking the advertisements based on the calculated scores (block 435). For example, marketing platform 230 may rank the advertisements based on the calculated scores. In some implementations, marketing platform 230 may rank the advertisements based on the scores in ascending order, descending order, etc. For example, assume that marketing platform 230 identifies three offers (e.g., A, B, and C) in the marketing information, and calculates a score of 0.4 for offer A, a score of 0.7 for offer B, and a score of 0.5 for offer C. In such an example, marketing platform 230 may rank offers A-C in descending order based on the scores, for example, as: (1) offer B, (2) offer C, and (3) offer A.

As shown in FIG. 4B, process 400 may include correlating the advertisements with the user segments based on the ranks of the advertisements (block 440). For example, marketing platform 230 may correlate the advertisements with the user segments based on the ranks of the advertisements. In some implementations, marketing platform 230 may correlate one or more particular advertisements with a particular user segment based on the products/services associated with the particular advertisements and based on the interests of the particular user segment. For example, assume that marketing platform 230 identifies a particular user segment that is interested in a particular car, and identifies three advertisements (e.g., A, B, and C) for the particular car in the marketing information. Further, assume that marketing platform 230 calculates a score of 0.2 for advertisement A, a score of 0.3 for advertisement B, and a score of 0.7 for advertisement C based on the factors and the assigned weights associated with the marketing information. In such an example, marketing platform 230 may correlate advertisements A-C with the particular user segment, may correlate advertisement C with the particular user segment since advertisement C has the greatest score, etc. In some implementations, marketing platform 230 may correlate, with the user segments, all of the advertisements, advertisements with scores greater than a particular threshold, a top percentage of advertisements based on the scores, etc.

In some implementations, marketing platform 230 may correlate, with a particular user segment, an advertisement with a greatest ranking for the particular user segment. For example, assume that marketing platform 230 identifies three offers A-C for a particular user segment, and calculates a score of 0.4 for offer A, a score of 0.7 for offer B, and a score of 0.5 for offer C. In such an example, marketing platform 230 may rank offers A-C based on the scores (e.g., as (1) offer B, (2) offer C, and (3) offer A), and may correlate offer B with the particular user segment based on the ranking, since offer B has the greatest score.

In some implementations, marketing platform 230 may not utilize the ranks of the advertisements, and may correlate the advertisements with the user segments, based on the scores associated with advertisements. For example, assume that marketing platform 230 identifies three advertisements A-C for a particular user segment, and calculates a score of 0.4 for advertisement A, a score of 0.7 for advertisement B, and a score of 0.5 for advertisement C. In such an example, marketing platform 230 may correlate advertisement A with the particular user segment since advertisement A has the lowest score.

As further shown in FIG. 4B, process 400 may include determining marketing channels for the correlated advertisements and user segments, based on marketing campaign information (block 445). For example, marketing platform 230 may determine marketing channels 240 for the correlated advertisements and user segments, based on marketing campaign information. In some implementations, the marketing campaign information may be provided in the marketing information and may include information associated with a marketing campaign for products and/or services, a marketing budget for the marketing campaign, timing associated with the marketing campaign, a number of advertisements for the marketing campaign, etc. In some implementations, devices associated with the determined marketing channels 240 may be segmented based on geography. For example, advertisements provided on television in Dallas, Tex. may be different than advertisements provided on television in New York City. In some implementations, devices associated with the determined marketing channels 240 may be segmented based on demographics associated with the user segments. For example, marketing channels 240 used to reach people living in Los Angeles may be different than marketing channels 240 used to reach people living in rural Michigan.

In some implementations, marketing platform 230 may receive, from user devices 210, performance information associated with advertisements provided by marketing channels 240 to user devices 210. The performance information may include, for example, information indicating whether the users receive the advertisements, purchase products/services associated with the advertisements, do nothing, request that the advertisements not be provided in the future, etc. In some implementations, marketing platform 230 may determine a performance matrix for all available marketing channels 240 based on the performance information. For example, the performance matrix may indicate that a first marketing channel 240 has a first success rate (e.g., for selling products/services), a second marketing channel 240 has a second success rate, a third marketing channel 240 has a third success rate, etc. Marketing platform 230 may utilize the performance matrix to determine marketing channels 240 for the correlated advertisements and user segments, based on marketing campaign information.

In some implementations, marketing platform 230 may utilize machine learning and/or a portfolio optimization problem, such as a convex optimization problem, to determine marketing channels 240 for the correlated advertisements and user segments, based on marketing campaign information. For example, marketing platform 230 may attempt to maximize an expected revenue generated by the marketing campaign (e.g., via the determined marketing channels 240) based on constraints (e.g., the marketing budget for the marketing campaign, the timing associated with the marketing campaign, the number of advertisements for the marketing campaign, etc.). In some implementations, the convex optimization problem may include the following form:

minimize ƒ₀(x)

subject to ƒᵢ(x)≦bi, i=1, . . . , m,

where x=(x₁, . . . , xₙ) is an optimization variable of the problem (e.g., the performance matrix for marketing channels 240), function ƒ₀: Rⁿ→R is an objective function, functions ƒᵢ: Rⁿ→R, i=1, . . . , m, are constraint functions, and constants b₁, . . . , bₘ are the limits, or bounds, for the constraints. A vector x* may be called an optimal (e.g., the determined marketing channels 240), or a solution of the problem if vector x* has a smallest objective value among all vectors that satisfy the constraints (e.g., for any z with ƒ₁(z)≦b₁, . . . , ƒₘ(z)≦bₘ, ƒ₀(z)≧ƒ₀(x*)).

As further shown in FIG. 4B, process 400 may include causing the advertisements to be provided to corresponding user segments via the marketing channels (block 450). For example, marketing platform 230 may cause the advertisements to be provided to corresponding user segments (e.g., to user devices 210 associated with users in the user segments) via the determined marketing channels 240. In some implementations, marketing platform 230 may provide the advertisements to user devices 210 associated with the corresponding user segments, via marketing channels 240. For example, assume that marketing platform 230 determines that an advertisement for an antique furniture store is to be provided to user devices 210 associated with users interested in antique furniture via an email message. In such an example, marketing platform 230 may generate the email message, with the advertisement, and may provide the email message to a marketing channel 240 (e.g., an email server device). Marketing channel 240 may provide the email message to user devices 210 associated with the users interested in antique furniture.

In some implementations, marketing platform 230 may instruct marketing channels 240 to provide the advertisements to user devices 210 associated with the corresponding user segments. For example, assume that marketing platform 230 determines that an offer for a free cup of coffee at a coffee shop is to be provided, to user devices 210 associated with users who frequently drink coffee at the coffee shop, via a SMS message. In such an example, marketing platform 230 may instruct a marketing channel 240 (e.g., an SMS server device) to generate the SMS message, with the offer for the free cup of coffee. Marketing channel 240 may provide the SMS message to user devices 210 associated with the users who frequently drink coffee at the coffee shop.

In some implementations, marketing platform 230 may utilize the user information (e.g., mobility information associated with user devices 210, location information associated with user devices 210, user product/service preferences, etc.) and/or the marketing information to create effective advertisements. For example, marketing platform 230 may utilize such user information to determine an optimal time period and frequency for retargeting users with particular advertisements, as well as to determine products/services to cross sell with the particular advertisements.

In some implementations, marketing platform 230 may utilize the user information (e.g., mobility information associated with user devices 210, location information associated with user devices 210, user product/service preferences, etc.) and/or the marketing information to provide particular users with instant offers based on the locations of the particular users. For example, if marketing platform 230 determines that the particular users are located at a shopping mall, marketing platform 230 may cause marketing channel 240 to provide (e.g., via SMS messages) offers, associated with stores in the shopping mall, to user devices 210 associated with the particular users.

In some implementations, marketing platform 230 may utilize the user information (e.g., historical information associated with a particular user's product/service purchases, etc.) and/or the marketing information to provide the particular user with advertisements that may influence the particular user to a particular brand of product or service. For example, if marketing platform 230 determines that the particular user frequently purchases potato chips, marketing platform 230 may cause an advertisement associated with a particular brand of potato chips to be provided to a user device 210 associated with the particular user.

As further shown in FIG. 4B, process 400 may include receiving feedback associated with the advertisements from the user segments (block 455). For example, marketing platform 230 may receive feedback associated with the advertisements from user devices 210 associated with the users of the user segments. In some implementations, marketing platform 230 may receive the feedback directly from user devices 210 associated with the users of the user segments. In some implementations, user devices 210 associated with the users of the user segments may provide the feedback to marketing systems 220 (e.g., via marketing channels 240), and marketing systems 220 may provide the feedback to marketing platform 230. In some implementations, the feedback may include information indicating whether the users receive the advertisements, purchase products/services associated with the advertisements, do nothing, request that the advertisements not be provided in the future, etc.

For example, assume that marketing platform 230 causes an advertisement for a fishing rod to be provided to user devices 210 associate with three users (e.g., A, B, and C). Further, assume that user A utilizes a link from the advertisement to purchase the fishing rod online, that user B receives the advertisement but deletes the email, and that user C requests that such emails not be provided in the future. Information associated with the actions of users A-C may be provided as feedback to marketing platform 230.

As further shown in FIG. 4B, process 400 may include utilizing the feedback to refine the determination of the marketing channels for the advertisements (block 460). For example, marketing platform 230 may utilize the feedback to refine the determination of marketing channels 240 for the advertisements. In some implementations, marketing platform 230 may utilize the feedback to modify the performance matrix for marketing channels 240. In some implementations, marketing platform 230 may utilize the feedback to modify the portfolio optimization problem and/or the constraints for the portfolio optimization problem.

For example, based on feedback, marketing platform 230 may increase spending on advertising via a first type of marketing channel 240, which may decrease spending on advertising via other marketing channels 240. The decrease in spending on advertising via the other marketing channels 240 may affect the expected revenue generated by the marketing campaign. If the increase in spending on advertising via the first marketing channel 240 increases the expected revenue generated by the marketing campaign, marketing platform 230 may determine that the increase in spending is warranted. If the increase in spending on advertising via the first marketing channel 240 decreases the expected revenue generated by the marketing campaign, marketing platform 230 may determine that increase in spending is not warranted.

In another example, assume that a user of a mobile user device 210 views an advertisement for jeans and decides to buy the jeans from a store since the jeans are 20% off. The store may not know whether the user bought the jeans because the user saw the advertisement or based on window shopping. However, marketing platform 230 may know that the user receives the advertisement when the user was in a vicinity of the store (e.g., based on the location of the mobile user device 210). Therefore, marketing platform 230 may determine that the user went to the store and bought the jeans based on the advertisement.

In some implementations, marketing platform 230 may utilize the feedback to improve other functions provided by marketing platform 230, such as, for example, creating the user profiles, grouping of the user profiles into user segments, scoring and ranking of the advertisements, correlating the advertisements with the user segments, etc.

Although FIGS. 4A and 4B shows example blocks of process 400, in some implementations, process 400 may include additional blocks, fewer blocks, different blocks, or differently arranged blocks than those depicted in FIGS. 4A and 4B. Additionally, or alternatively, two or more of the blocks of process 400 may be performed in parallel.

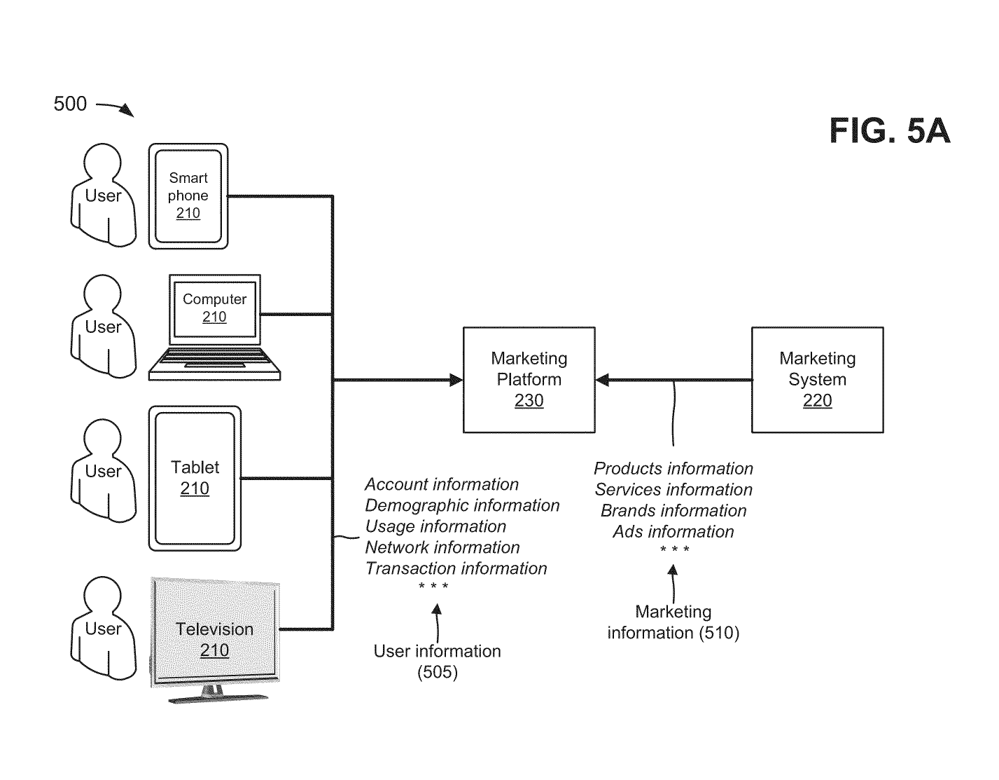

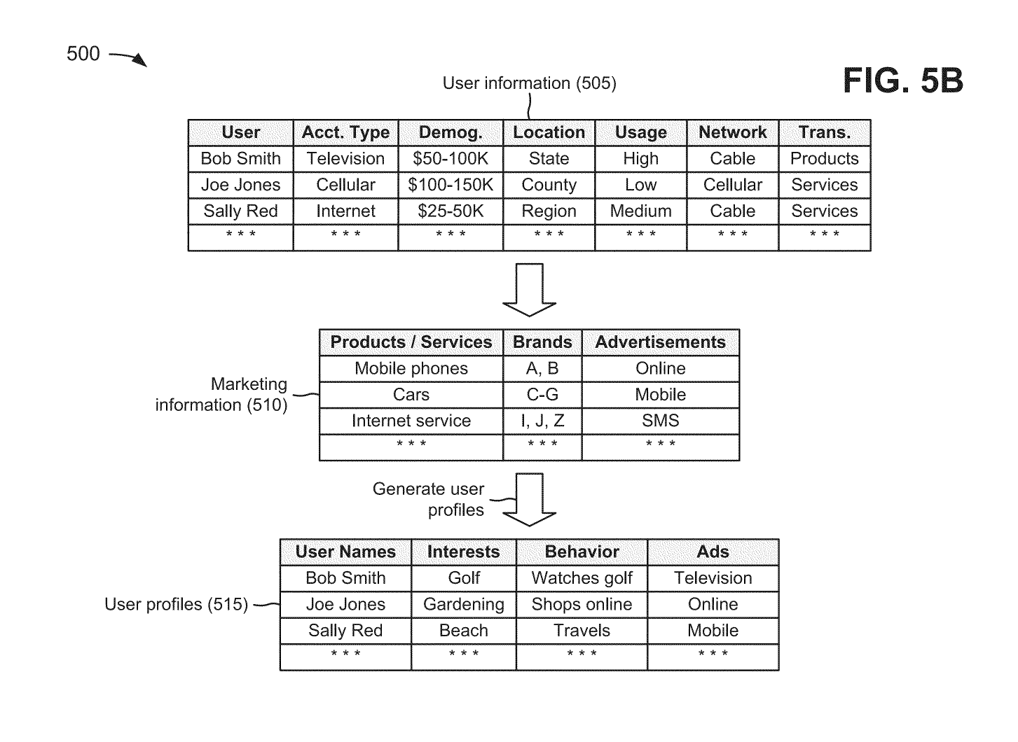

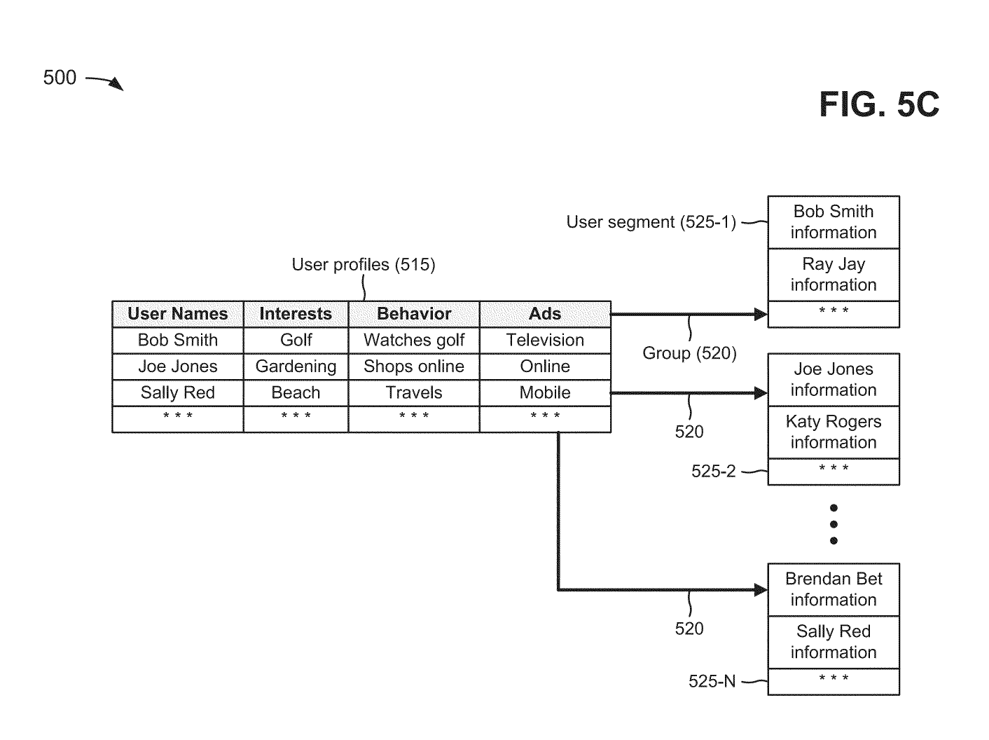

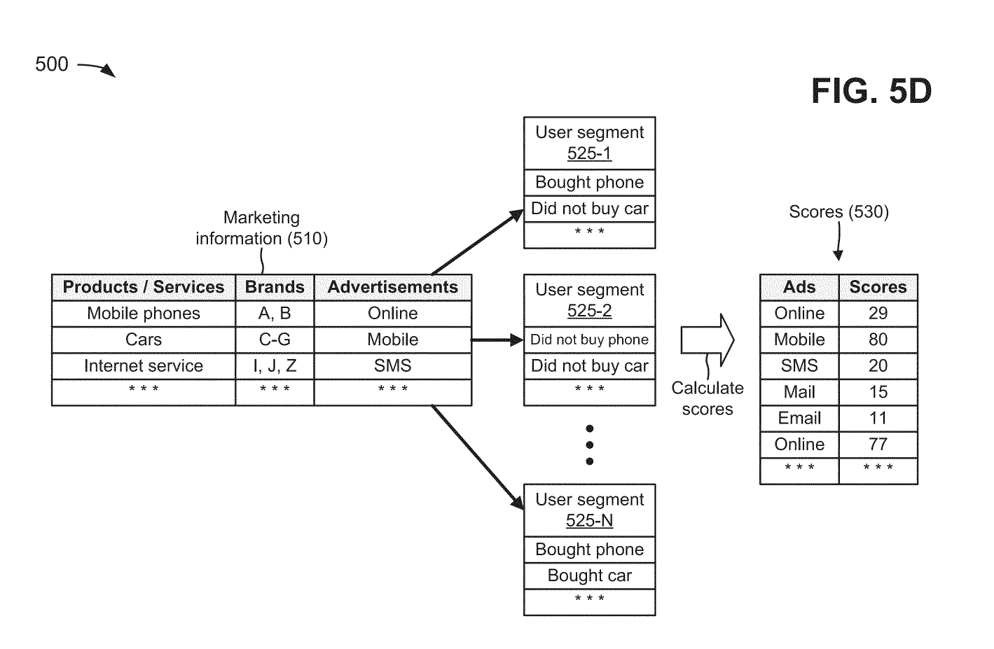

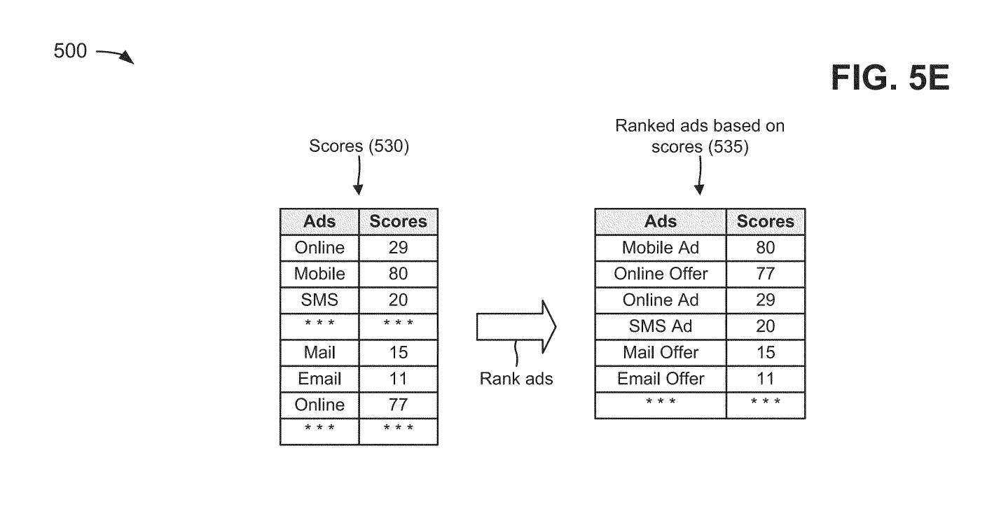

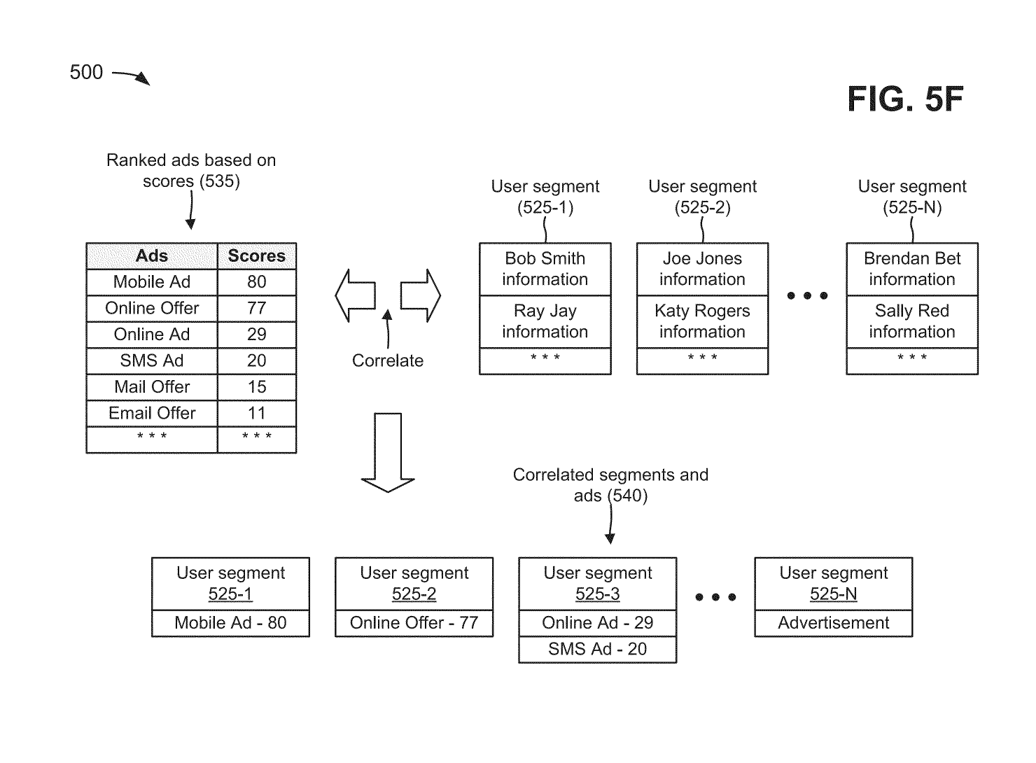

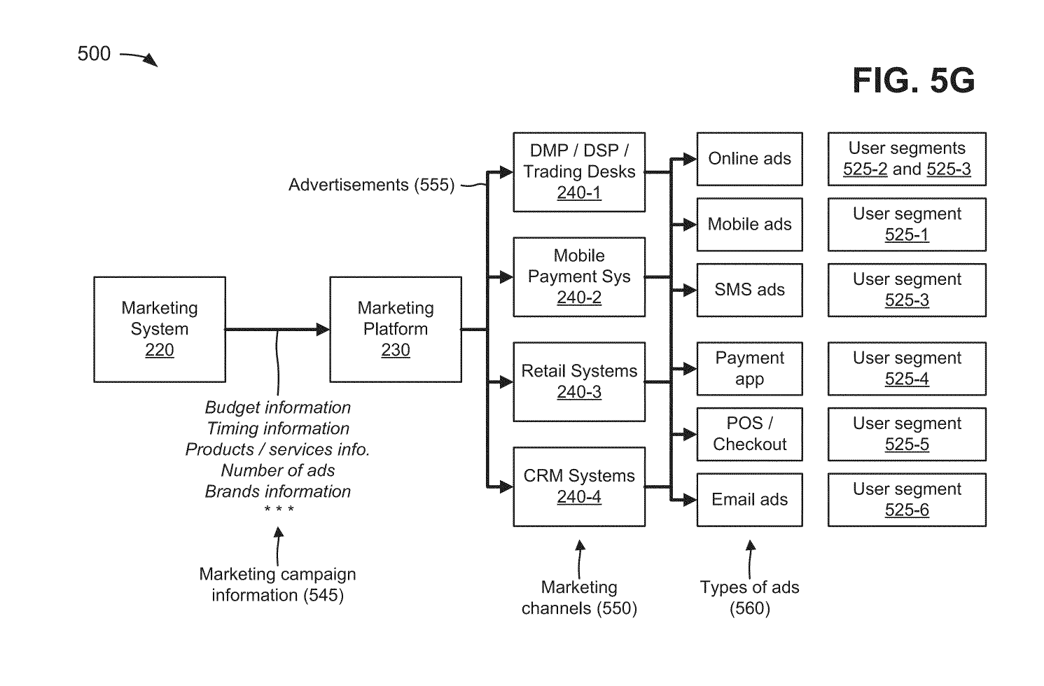

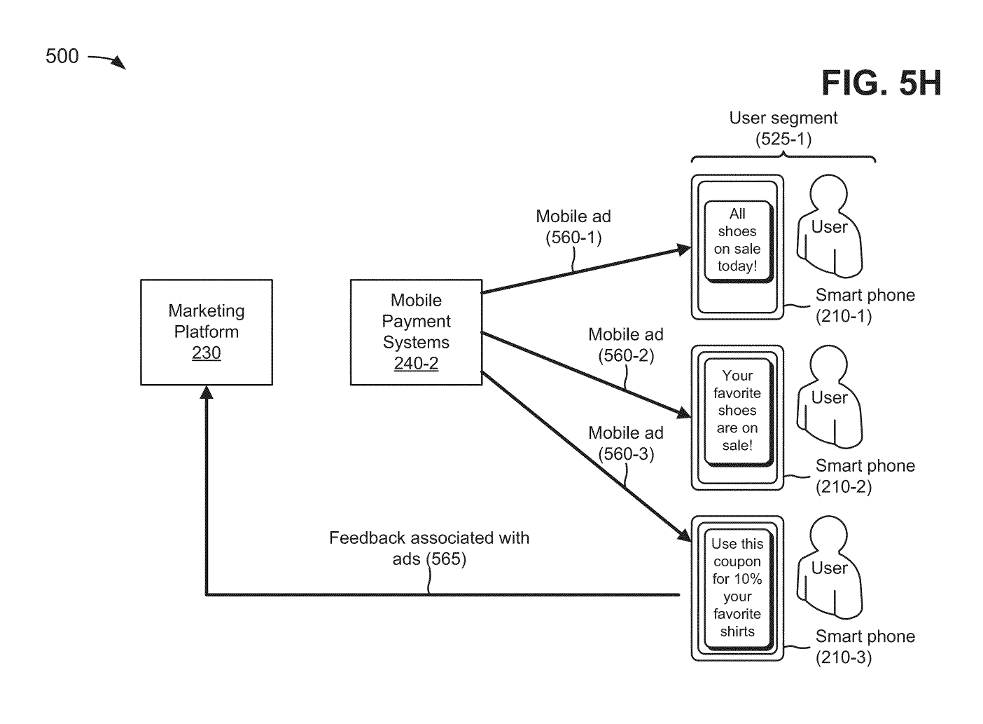

FIGS. 5A-5H are diagrams of an example 500 relating to example process 400 shown in FIGS. 4A and 4B. With reference to FIG. 5A, assume that users are associated with a variety of user devices 210 (e.g., smart phones, computers, tablets, televisions, etc.) that provide user information 505. User information 505 may include information associated with user devices 210 and the users (e.g., account information, demographic information, etc.); network information (e.g., information associated with network resources of network 250 utilized by user devices 210); network usage information associated with user devices 210; content accessed by user devices 210; transactions associated with user devices 210; clickstream information associated with user devices 210; location information associated with user devices 210; time information associated with user devices 210; etc. User devices 210 may provide user information 505 to marketing platform 230, and marketing platform 230 may receive user information 505.

As further shown in FIG. 5A, marketing system 220 may provide marketing information 510 that includes information associated with products and/or services offered by vendors and to be marketed to the users; advertisements for the products and/or the services offered by the vendors; offers for the products and/or the services; brands information; marketing campaign information; user information 505 received by the vendors via interactions between the vendors and the users; etc. Marketing system 220 may provide marketing information 510 to marketing platform 230, and marketing platform 230 may receive marketing information 510.

As shown in FIG. 5B, marketing platform 230 may store user information 505 in a data structure (e.g., a tree, a table, a list, a database, etc.) that includes a user field, an account type field, a demographic field, a location field, a usage field, a network field, a transaction field, and multiple entries associated with the fields. The user field may include information identifying the users of user devices 210, such as, for example, names, user identifiers, user account numbers, etc. The account type field may include information identifying types of accounts associated with the users, such as, for example, a television service account, a cellular service account, an Internet service account, etc. The demographic field may include information identifying demographics of the users, such as, for example, income levels of the users, education levels of the users, age, race, etc. The location field may include information identifying current and past locations of the users, such as, for example, within a state, a county, a region, GPS coordinates, etc. The usage field may include information identifying network usage by the users, such as, for example, high network usage, medium network usage, low network usage, bandwidth utilization, etc. The transaction field may include information identifying transactions performed by the users with user devices 210, such as, for example, transactions for products, services, etc.

As further shown in FIG. 5B, marketing platform 230 may store marketing information 510 in a data structure that includes a products/services field, a brands field, an advertisements field, and multiple entries associated with the fields. The products/services field may include information identifying products/services that vendors wish to sell to the users of user devices 210, such as, for example, mobile phones, cars, an Internet service, etc. The brands field may include information identifying brands associated with the products/services, such as, for example, brands A and B for the mobile phones, brands C-G for the cars, brands I, J, and Z for the Internet service, etc. The advertisements field may include information identifying advertisements associated with the products/services, such as, for example, online advertisements for the mobile phones, mobile advertisements for the cars, SMS advertisements for the Internet service, etc.

Marketing platform 230 may generate user profiles 515 based on user information 505 and marketing information 510, as further shown in FIG. 5B. A particular user profile 515, for a particular user, may include a user identifier (e.g., a user name) and multiple attributes associated with the particular user (e.g., demographic information, location information, time information, user device information, interests, behavior, advertisements received, etc.). As shown, marketing platform 230 may store user profiles 515 in a data structure that includes a user names field, an interests field, a behavior field, an advertisements field, and multiple entries associated with the fields. The user names field may include information identifying the names of the users of user devices 210, such as, for example, Bob Smith, Joe Jones, Sally Red, etc. The interests field may include information identifying interests of the users, such as, for example, golf, gardening, beach, etc. The behavior field may include information identifying behaviors of the users, such as, for example, watching golf, shopping online, traveling, etc. The advertisements field may include information identifying advertisements received by the users, such as, for example, television advertisements, online advertisements, mobile advertisements, etc.

As shown in FIG. 5C, marketing platform 230 may group 520 user profiles 515 together, into user segments 525, based on user information 505, marketing information 510, and/or information provided in user profiles 515. For example, marketing platform 230 may group information associated with Bob Smith, Ray Jay, etc. into a user segment 525-1 that is interested in golf and watches golf on television. Marketing platform 530 may group information associated with Joe Jones, Katy Rogers, etc. into a user segment 525-2 that is interested in gardening and shops online for gardening equipment. Marketing platform 530 may group information associated with Brendan Bet, Sally Red, etc. into a user segment 525-N that is interested in the beach and travels to the beach. Marketing platform 230 may store user segments 525 in one or more data structures.

As shown in 5D, marketing platform 230 may identify advertisements in marketing information 510 (e.g., in the advertisements field), and may calculate scores 530 for the advertisements based on marketing information 510 and/or user segments 525. For example, marketing platform 230 may determine whether users in user segments 525 purchased products/services based on the advertisements, and may score the advertisements accordingly. As shown, assume that marketing platform 230 determines a score of “29” for online advertisements associated with the mobile phones, a score of “80” for mobile advertisements associated with golf, a score of “20” for SMS advertisements associated with the Internet service. As further shown, assume that marketing platform 230 determines a score of “15” for mail offers associated with the mobile phones, a score of “11” for email offers associated with the cars, a score of “77” for online offers associated with gardening.

As shown in FIG. 5E, marketing platform 230 may rank the advertisements in descending order based on the calculated scores 530 in order to generate ranked advertisements 535. For example, marketing platform 230 may rank the mobile advertisements associated with golf first (e.g., score of “80”), the online offers associated with gardening second (e.g., score of “77”), the online advertisements for the mobile phones third (e.g., score of “29”), the SMS advertisements for the Internet service fourth (e.g., score of “20”), the mail offer for the mobile phones fifth (e.g., score of “15”), the email offer for the cars sixth (e.g., score of “11”), etc.

As shown in FIG. 5F, marketing platform 230 may correlate ranked advertisements 535 with user segments 525, based on the rankings, to create correlated user segments and advertisements 540. For example, marketing platform 230 may correlate the mobile advertisements associated with golf (e.g., score of “80”) with user segment 525-1, may correlate the online offers associated with gardening (e.g., score of “77”) with user segment 525-2, may correlate the online advertisements for the mobile phones (e.g., score of “29”) and the SMS advertisements for the Internet service (e.g., score of “20”) with user segment 525-3, etc.

As shown in FIG. 5G, marketing system 520 may provide marketing campaign information 545 to marketing platform 230. Marketing campaign information 545 may include information associated with a marketing campaign for products and/or services, a marketing budget for the marketing campaign, timing associated with the marketing campaign, information associated with the products/services, a number of advertisements for the marketing campaign, brands information for the products/services, etc. Marketing platform 230 may determine marketing channels 550 for correlated user segments and advertisements 540, based on marketing campaign information 545. Marketing channels 550 may include, for example, DMP/DSP/trading desks 240-1, mobile payment systems 240-2, retail systems 240-3, CRM systems 240-4, etc. Marketing platform 230 may provide the advertisements to marketing channels 550, as indicated by reference number 555. Marketing channels 550 may deliver advertisements 555 to user segments 525 in a variety of ways, as indicated by reference number 560 in FIG. 5G. For example, any of marketing channels 550 may deliver advertisements 555 via an online advertisement, a mobile advertisement, a SMS advertisement, a payment application, a POS/checkout device, an email advertisement, etc. As further shown in FIG. 5G, marketing channels 550 may deliver online advertisements 555 to user segments 525-2 and 525-3, may deliver mobile advertisements 555 to user segment 525-1, may deliver SMS advertisements 555 to user segment 525-3, may utilize a payment application for user segment 525-4, may utilize a POS/checkout device for user segment 525-5, and may deliver email advertisements 555 to user segment 525-6.

As shown in FIG. 5H, assume that user segment 525-1 includes three users associated with smart phones 210-1, 210-2, and 210-3. Mobile payment systems 240-2 may deliver, to a first smart phone 210-1, a mobile advertisement 560-1 that indicates that all shoes are on sale today. Mobile payment systems 240-2 may deliver, to a second smart phone 210-2, a mobile offer 560-2 that indicates that the second user's favorite shoes are on sale. Mobile payment systems 240-2 may deliver, to a third smart phone 210-3, a mobile offer 560-3 that includes a coupon to get 10% off the third user's favorite shirts. The three users may purchase products based on mobile advertisements 560 or may do nothing based on mobile advertisements 560. Such information may be provided as feedback 565 to marketing platform 230, as further shown in FIG. 5H. Marketing platform 230 may utilize feedback 565 to refine the determination of marketing channels 550 for advertisements 555.

As indicated above, FIGS. 5A-5H are provided merely as an example. Other examples are possible and may differ from what was described with regard to FIGS. 5A-5H.

Systems and/or methods described herein may determine advertisements for user segments and appropriate marketing channels for the advertisements. The systems and/or methods may ensure that personalized advertisements are delivered to appropriate users, via appropriate marketing channels and at appropriate times and locations. The systems and/or methods may enable vendors to allocate marketing budgets so that the advertisements are provided to users in a most productive manner.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The foregoing disclosure provides illustration and description, but is not intended to be exhaustive or to limit the implementations to the precise form disclosed. Modifications and variations are possible in light of the above disclosure or may be acquired from practice of the implementations.

A component is intended to be broadly construed as hardware, firmware, or a combination of hardware and software.

User interfaces may include graphical user interfaces (GUIs) and/or non-graphical user interfaces, such as text-based interfaces. The user interfaces may provide information to users via customized interfaces (e.g., proprietary interfaces) and/or other types of interfaces (e.g., browser-based interfaces, etc.). The user interfaces may receive user inputs via one or more input devices, may be user-configurable (e.g., a user may change the sizes of the user interfaces, information displayed in the user interfaces, color schemes used by the user interfaces, positions of text, images, icons, windows, etc., in the user interfaces, etc.), and/or may not be user-configurable. Information associated with the user interfaces may be selected and/or manipulated by a user (e.g., via a touch screen display, a mouse, a keyboard, a keypad, voice commands, etc.).

It will be apparent that systems and/or methods, as described herein, may be implemented in many different forms of hardware, firmware, and/or combinations of software and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method, comprising:
receiving, by a device, user information associated with users of user devices;
receiving, by the device, marketing information associated with products and services, the marketing information including marketing campaign information and
information associated with advertisements for the products and the services, and the marketing campaign information including one or more of:
information associated with a marketing campaign for the products and the services,
information associated with a marketing budget for the marketing campaign,
timing information associated with the marketing campaign, or
information associated with a number of advertisements for the marketing campaign;
creating, by the device, user profiles, associated with the users, based on the user information and the marketing information;
grouping, by the device, the user profiles based on the user information to create user segments;
generating, by the device, scores for the advertisements based on the marketing information;
correlating, by the device, the advertisements with users of the user segments based on the scores for the advertisements;
determining, by the device, marketing channels for the advertisements based on the marketing campaign information and the correlated user segments; and
causing, by the device, the advertisements to be provided to user devices associated with the users of the correlated user segments, via the determined marketing channels.

2. The method of claim 1, further comprising:
receiving feedback from the user devices associated with the users of the correlated user segments; and
utilizing the feedback to refine the grouping of the user profiles to create the user segments.

3. The method of claim 1, further comprising:
receiving feedback from the user devices associated with the users of the correlated user segments; and
utilizing the feedback to refine the correlation of the advertisements with the users of the user segments.

4. The method of claim 1, where generating the scores for the advertisements comprises:
assigning weights to the marketing information; and
calculating the scores for the advertisements based on the assigned weights.

5. The method of claim 1, where determining the marketing channels for the advertisements further comprises:
utilizing the marketing campaign information in a convex optimization problem; and
solving the complex optimization problem, based on the marketing campaign information, to determine the marketing channels for the advertisements.

6. The method of claim 1, further comprising:
receiving feedback from the user devices associated with the users of the correlated user segments; and
utilizing the feedback to refine the determination of the marketing channels for the advertisements.

7. The method of claim 1, where each of the user profiles includes a user identifier for a particular user and a plurality of attributes associated with the particular user.

8. A system, comprising:
one or more devices to:
receive user information associated with users of user devices;
receive marketing information associated with products and services, the marketing information including marketing campaign information and
information associated with advertisements for the products and the services, and the marketing campaign information including one or more of:
information associated with a marketing campaign for the products and the services,
information associated with a marketing budget for the marketing campaign,
timing information associated with the marketing campaign, or
information associated with a number of advertisements for the marketing campaign;
generate user profiles, associated with the users, based on the user information and the marketing information;
group the user profiles based on the user information to create user segments;
generate scores for the advertisements based on the marketing information;
correlate the advertisements with users of the user segments based on the scores for the advertisements;
determine marketing channels for the advertisements based on the marketing campaign information and the correlated user segments; and
cause the advertisements to be provided to user devices associated with the users of the correlated user segments, via the determined marketing channels.

9. The system of claim 8, where the one or more devices are further to:
receive feedback from the user devices associated with the users of the correlated user segments; and
utilize the feedback to refine the grouping of the user profiles to create the user segments.

10. The system of claim 8, where the one or more devices are further to:
receive feedback from the user devices associated with the users of the correlated user segments; and
utilize the feedback to refine the correlation of the advertisements with the users of the user segments.

11. The system of claim 8, where, when generating the scores for the advertisements, the one or more devices are further to:
assign weights to the marketing information; and
calculate the scores for the advertisements based on the assigned weights.

12. The system of claim 8, where, when determining the marketing channels for the advertisements, the one or more devices are further to:
utilize the marketing campaign information in a convex optimization problem; and
solve the complex optimization problem, based on the marketing campaign information, to determine the marketing channels for the advertisements.

13. The system of claim 8, where the one or more devices are further to:
receive feedback from the user devices associated with the users of the correlated user segments; and
utilize the feedback to refine the determination of the marketing channels for the advertisements.

14. The system of claim 8, where each of the user profiles includes a user identifier for a particular user and a plurality of attributes associated with the particular user.

15. A computer-readable medium for storing instructions, the instructions comprising:
one or more instructions that, when executed by one or more processors of a device, cause the one or more processors to:
receive user information associated with users of user devices;
receive marketing information associated with products and services, the marketing information including information associated with
advertisements for the products and the services;
generate user profiles, associated with the users, based on the user information and the marketing information;
group the user profiles based on the user information to create user segments;
generate scores for the advertisements based on the marketing information;
correlate the advertisements with users of the user segments based on the scores for the advertisements;
determine marketing channels for the advertisements based on the marketing information and the correlated user segments; and
cause the advertisements to be provided to user devices associated with the users of the correlated user segments, via the determined marketing channels.

16. The computer-readable medium of claim 15, further comprising:
one or more instructions that, when executed by the one or more processors, cause the one or more processors to:
receive feedback from the user devices associated with the users of the correlated user segments; and
utilize the feedback to modify the grouping of the user profiles to create the user segments.

17. The computer-readable medium of claim 15, further comprising:
one or more instructions that, when executed by the one or more processors, cause the one or more processors to:
receive feedback from the user devices associated with the users of the correlated user segments; and
utilize the feedback to modify the correlation of the advertisements with the users of the user segments.

18. The computer-readable medium of claim 17, where the instructions that cause the one or more processors to generate the scores for the advertisements further comprise:
one or more instructions that, when executed by the one or more processors, cause the one or more processors to:
assign weights to the marketing information; and
calculate the scores for the advertisements based on the assigned weights.

19. The computer-readable medium of claim 15, where the instructions that cause the one or more processors to determine the marketing channels for the advertisements further comprise:
one or more instructions that, when executed by the one or more processors, cause the one or more processors to:
utilize the marketing campaign information in a convex optimization problem; and
solve the complex optimization problem, based on the marketing campaign information, to determine the marketing channels for the advertisements.

20. The computer-readable medium of claim 15, further comprising:
one or more instructions that, when executed by the one or more processors, cause the one or more processors to:
receive feedback from the user devices associated with the users of the correlated user segments; and
utilize the feedback to modify the determination of the marketing channels for the advertisements.
